(19) United States
(12) Patent Application Publication
(10) Pub. No.: US 2026/0301428 A1
(43) Pub. Date: Oct. 1, 2026

(54) ROAD SURFACE CONDITION DETERMINATION DEVICE, SERVER DEVICE, MOVING OBJECT, ROUTE SEARCHING DEVICE, ROAD SURFACE CONDITION DETERMINATION METHOD, AND STORAGE MEDIUM

(71) Applicant: HONDA MOTOR CO., LTD., Tokyo (JP)

(72) Inventor: Kimihiko Hiroi, Wako-shi (JP)

(21) Appl. No.: 19/558,752

(22) Filed: Mar. 6, 2026

(30) Foreign Application Priority Data
Mar. 28, 2025 (JP) 2025-056762

(51) Int. Cl. G06V 20/56; G01C 21/34; G06V 10/44

(52) U.S. Cl. CPC G06V 20/588; G01C 21/3453; G06V 10/454

(57) ABSTRACT

A road surface condition determination device includes an image acquisition unit for chronologically acquiring a road surface image and behavior information such that the road surface image and the behavior information are associated with each other, the road surface image being obtained by capturing an image of a road surface on which a moving object is traveling, the behavior information being indicative of behavior of the moving object at the time when the road surface image is captured, an extraction unit for extracting a part of the plurality of the road surface images, and a road surface condition determination unit for determining the road surface condition by processing the extracted image.

### CROSS-REFERENCE TO RELATED APPLICATIONS

This application is based upon and claims the benefit of priority from Japanese Patent Application No. 2025-056762 filed on Mar. 28, 2025, the contents of which are incorporated herein by reference.

### BACKGROUND OF THE INVENTION

### Field of the Invention

The present disclosure relates to a road surface condition determination device, a server device, a moving object, a route searching device, a road surface condition determination method, and a storage medium.

### Description of the Related Art

In WO 2022/208765 A1, there is disclosed a server device that analyzes road information and thereby determines a road surface condition.

### SUMMARY OF THE INVENTION

There is a long awaited need for a more satisfactory device for determining a road surface condition.

The present disclosure has the object of solving the aforementioned problem.

A first aspect of the present disclosure is characterized by a road surface condition determination device comprising an image acquisition unit configured to chronologically acquire a road surface image and behavior information in a manner so that the road surface image and the behavior information are associated with each other, the road surface image being obtained by capturing an image of the road surface on which a moving object is traveling, the behavior information being indicative of behavior of the moving object at a time when the road surface image is captured, an extraction unit configured to extract, as an extracted image, the road surface image that is a part of a plurality of the road surface images, based on the behavior information, and a road surface condition determination unit configured to determine a condition of the road surface, as a road surface condition, by processing the extracted image.

A second aspect of the present disclosure is characterized by a server device in an information processing system comprising a moving object, and a server device configured to be capable of communicating with the moving object, the server device comprising the road surface condition determination device according to the first aspect.

A third aspect of the present disclosure is characterized by a moving object equipped with the road surface condition determination device according to the first aspect.

A fourth aspect of the present disclosure is characterized by a route searching device configured to search for a route in order for a moving object to arrive from a starting node representing a departure point to an ending node representing a destination point, using a graph made up from nodes representing points and edges representing a partial route connecting two points, each of the edges being associated with cost information indicating a cost required for the moving object to travel on the partial route corresponding to the edges, the route searching device comprising a weighting coefficient setting unit configured to set a weighting coefficient in order to correct the cost, corresponding to the road surface condition of the partial route as determined by the road surface condition determination device according to the fourth aspect, and a searching unit configured to search for the route based on the cost that has been corrected using the weighting coefficient.

A fifth aspect of the present disclosure is characterized by a road surface condition determination method comprising chronologically acquiring a road surface image and behavior information in a manner so that the road surface image and the behavior information are associated with each other, the road surface image being obtained by capturing an image of the road surface on which a moving object is traveling, the behavior information being indicative of behavior of the moving object at a time when the road surface image is captured, extracting, as an extracted image, the road surface image that is a part of a plurality of the road surface images, based on the behavior information, and determining a condition of the road surface, as a road surface condition, by processing the extracted image.

A sixth aspect of the present disclosure is characterized by a program for causing a computer to execute the road surface condition determination method according to the fifth aspect.

A seventh aspect of the present disclosure is characterized by a computer readable non-transitory storage medium in which there is stored the program according to the sixth aspect.

According to the present disclosure, a more satisfactory road surface condition determination device and the like can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing the configuration of an operation management system according to an embodiment;

FIG. 2 is a block diagram showing the configuration of a moving object according to the embodiment;

FIG. 3 is a block diagram showing the configuration of a server device according to the embodiment;

FIG. 4 is a diagram showing an example of map information that is stored in a database;

FIG. 5 is a diagram showing an example of traveling information that is stored in the database;

FIG. 6 is a diagram showing image information that is stored in the database;

FIG. 7 is a diagram illustrating a reference line;

FIG. 8 is a diagram illustrating an amount of deviation;

FIG. 9 is a diagram illustrating frequency components of the amount of deviation;

FIG. 10 is a diagram illustrating frequency components of the amount of deviation;

FIG. 11 is a graph showing a change over time of a moving object velocity, a first derivative of the moving object velocity, and a second derivative of the moving object velocity;

FIG. 12 is a diagram illustrating a specific region on extracted images;

FIG. 13 is a diagram illustrating a target region on a road surface;

FIG. 14 is a diagram illustrating a conversion from the target region on the road surface to the specific region on the extracted images;

FIG. 15 is a diagram illustrating a method of converting a position of a specific point on a road surface into a position of a point on a road surface image;

FIG. 16 is a diagram illustrating a processing region;

FIG. 17 is a diagram showing processing by a convolutional neural network;

FIG. 18 is a diagram illustrating a determination of a road surface condition with respect to extracted images;

FIG. 19 is a diagram illustrating a travel time period;

FIG. 20 is a table showing an example of the travel time period, a first travel time period, a second travel time period, and a rough road probability of a partial route when the moving object has traveled along the partial route;

FIG. 21 is a diagram showing the map information after costs have been corrected by a weighting coefficient;

FIG. 22 is a flowchart showing a road surface condition determination process executed by a road surface condition determination device; and

FIG. 23 is a flowchart showing a route searching process executed by a route searching device.

### DETAILED DESCRIPTION OF THE INVENTION

Conventionally, a road surface condition determination method has been proposed in which the road surface condition is determined by processing road surface images. However, since the image processing load is large, time is required for such image processing. Moreover, in order to shorten the processing time, it is necessary to use a computation unit of a high cost.

In the road surface condition determination method and the like according to the present disclosure, it is possible to reduce the image processing load.

### EMBODIMENTS

### Operation Control System

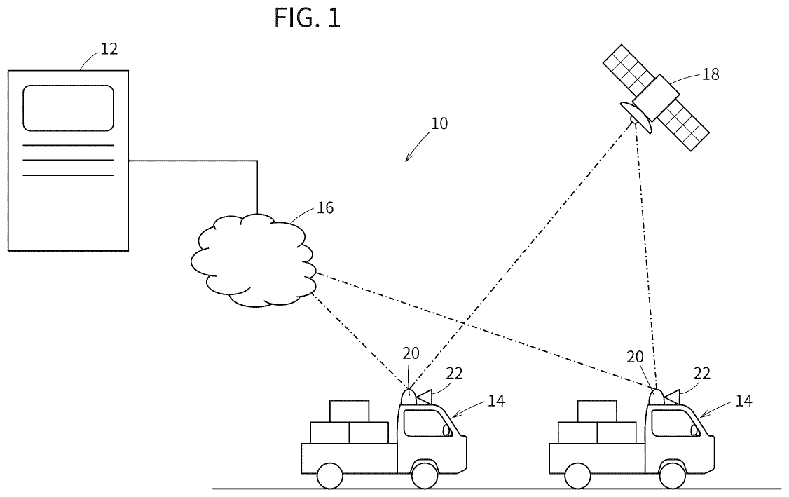

FIG. 1 is a schematic diagram showing the configuration of an operation management system 10 according to an embodiment. The operation management system 10 corresponds to an information processing system of the present invention. The operation management system 10 is equipped with a server device 12, and a plurality of moving objects 14. The server device 12 and the moving objects 14 are capable of communicating with each other via a network 16 such as the Internet or the like.

The moving objects 14 are objects that are capable of moving autonomously, such as autonomous vehicles having wheels. The moving objects 14 may be multi-legged robots or the like. The moving objects 14, for example, carry out an operation of delivering a package. The moving objects 14 may be used for carrying out a mowing operation, a cultivation operation, or the like.

Each of the moving objects 14 is equipped with a GPS (Global Positioning System) receiving device 20 that receives signals from GPS satellites 18. The GPS receiving device 20 calculates the position of the moving objects 14 based on the signals received from the GPS satellites 18. Hereinafter, the position of the moving objects 14 may be referred to as a moving object position.

Each of the moving objects 14 is equipped with a camera 22 that photographs the surface of the road on which the moving object 14 is traveling. The camera 22 captures images of the road surface, and thereby acquires road surface images. The camera 22 corresponds to an imaging device of the present invention.

### Moving Objects

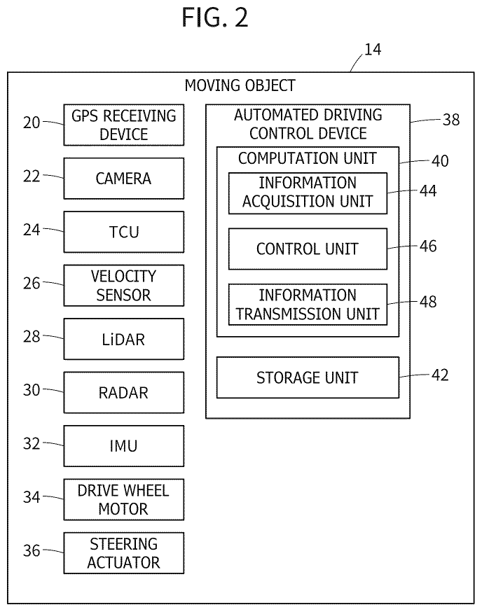

FIG. 2 is a block diagram showing the configuration of the moving objects 14 according to the embodiment. Each of the moving objects 14 is equipped with the GPS receiving device 20, the camera 22, a TCU (Telematics Control Unit) 24, a velocity sensor 26, a LiDAR (Light Detection And Ranging) 28, a RADAR (Radio Detection And Ranging) 30, an IMU (Inertial Measurement Unit) 32, a drive wheel motor 34, and a steering actuator 36.

The GPS receiving device 20, as noted previously, calculates the position of the moving objects 14 based on the signals received from the GPS satellites 18. The moving object position is given in a geographic coordinate system indicated by latitude and longitude. The moving object position may be given in another coordinate system. The camera 22, as noted previously, photographs the surface of the road on which the moving objects 14 travel. The TCU 24 communicates bidirectionally via the network 16 with a device that is external to the moving objects 14. The device that is external to the moving objects 14, for example, is the server device 12.

The velocity sensor 26 detects the velocity of the moving objects 14. Hereinafter, the velocity of the moving objects 14 may be referred to as a moving object velocity. The velocity sensor 26 may detect the moving object velocity based on the rotational velocity of the vehicle wheels of the moving objects 14. The velocity sensor 26 may determine the moving object velocity based on the moving object position that is calculated based on the signals from the GPS satellites 18. The LiDAR 28 uses laser light and thereby carries out measurements of the distances to target objects, the shapes of the target objects, and the like. The RADAR 30 uses radio waves and thereby carries out measurements of the distances to the target objects, the directions of the target objects, and the like. The IMU 32 detects the acceleration and the angular velocity of the moving objects 14.

The drive wheel motor 34 rotatably drives the drive wheels of the moving objects 14, and thereby causes the moving objects 14 to move in frontward and rearward directions. The steering actuator 36 steers the steering wheel of the moving objects 14, and thereby causes the moving objects 14 to turn to the left and the right.

### Automated Driving Control Device

Each of the moving objects 14 is further equipped with an automated driving control device 38. The automated driving control device 38 includes a computation unit 40 and a storage unit 42.

The computation unit 40, for example, is a processor such as a CPU (Central Processing Unit), a GPU (Graphics Processing Unit), or the like. The computation unit 40 comprises an information acquisition unit 44, a control unit 46, and an information transmission unit 48. The information acquisition unit 44, the control unit 46, and the information transmission unit 48 can be realized by the computation unit 40 executing programs that are stored in the storage unit 42. At least a portion of the information acquisition unit 44, the control unit 46, and the information transmission unit 48 may be realized by an integrated circuit such as an ASIC (Application Specific Integrated Circuit), an FPGA (Field Programmable Gate Array), or the like. At least a portion of the information acquisition unit 44, the control unit 46, and the information transmission unit 48 may be realized by an electronic circuit including a discrete device.

The storage unit 42 is a computer readable non-transitory tangible storage medium. The storage unit 42 is constituted by a non-illustrated volatile memory and a non-illustrated nonvolatile memory. The volatile memory, for example, is a RAM (Random Access Memory). The nonvolatile memory, for example, is a ROM (Read Only Memory), a flash memory, or the like. Data and the like, for example, are stored in the volatile memory. Programs, tables, maps, and the like, for example, are stored in the nonvolatile memory. At least a portion of the storage unit 42 may be provided in the aforementioned processor, the integrated circuit, or the like. At least a portion of the storage unit 42 may be installed in a device that is connected via the network 16 to the moving objects 14.

The information acquisition unit 44 acquires information from the server device 12 via the network 16. The acquired information, for example, is information indicating target passing points, which are target points that will be passed through when the moving objects 14 are automatically driven. The control unit 46 controls the drive wheel motor 34 and the steering actuator 36, and thereby causes the moving objects 14 to move in a manner so as to pass through the target passing points.

The information transmission unit 48 transmits information to the server device 12 via the network 16. The information to be transmitted includes, for example, traveling information, image information, and the like. The traveling information includes information indicating the road surface condition of the road on which the moving objects 14 travel, and information indicating the moving object position and the moving object velocity and the like. The moving objects 14 determine, as the road surface condition, a rough road on which traveling is difficult, or a non-rough road on which traveling is not difficult. For example, the moving objects 14 may determine the road surface condition based on an amount of slippage of the drive wheels, a difference between a target yaw rate and the actual yaw rate, and the like. The image information is information indicating the road surface images that are captured by the aforementioned camera 22.

### Server Device

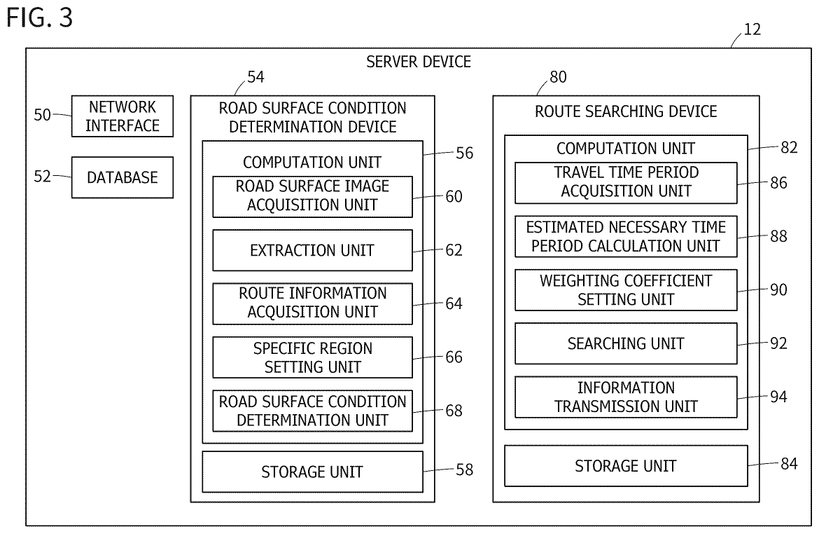

FIG. 3 is a block diagram showing the configuration of the server device 12 according to the embodiment. The server device 12 is equipped with a network interface 50. The network interface 50 carries out bidirectional communication via the network 16 with devices that are external to the server device 12. The devices that are external to the server device 12, for example, are the moving objects 14.

### Database

The server device 12 is further equipped with a database 52. Map information, traveling information, and image information are stored in the database 52.

### Map Information

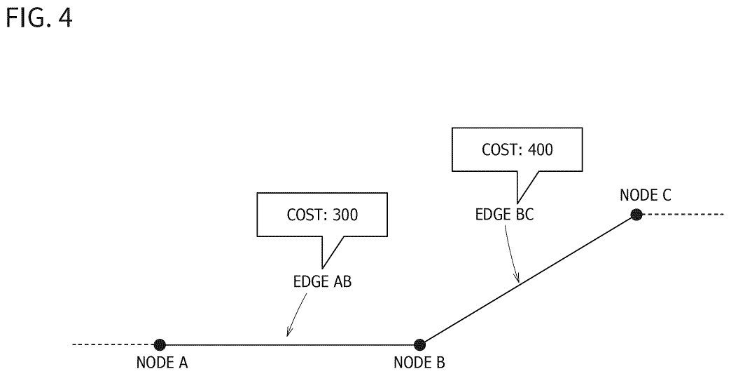

FIG. 4 is a diagram showing an example of the map information that is stored in the database 52. The map information is used to search for a route that the moving objects 14 will pass through from a departure point to a destination point. Hereinafter, a road that connects two points may be referred to as a partial route. Further, all the partial routes that are used to reach the destination point from the departure point may be referred to as a route.

The map information is represented by a graph consisting of a plurality of nodes and a plurality of edges. The nodes represent points, and the edges represent the partial route. Each of the edges is associated with a cost incurred by using the partial route corresponding to the edges. In the map information according to the present embodiment, the cost is a necessary time period required for the moving objects 14 to travel from a starting end to a terminal end of the partial route corresponding to the edges.

### Traveling Information

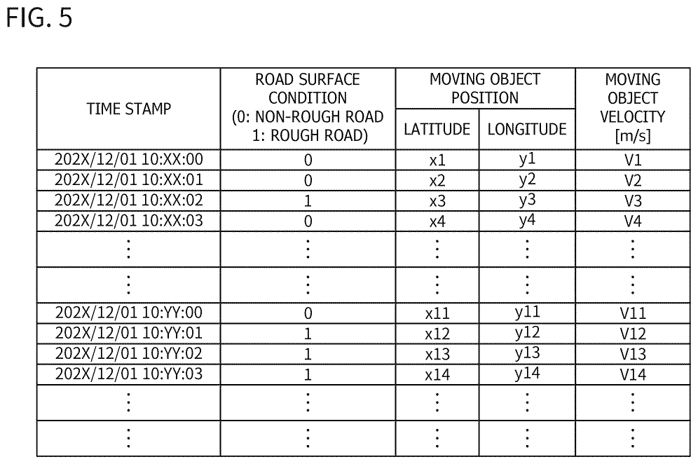

FIG. 5 is a diagram showing an example of the traveling information that is stored in the database 52. As shown in FIG. 5, the road surface condition, the moving object position, the moving object velocity, and the like are managed together with time stamps indicating the points in time when they were acquired.

In the database 52, there may be stored, as the traveling information, information other than the road surface condition, the moving object position, and the moving object velocity. For example, information such as the distance to target objects that are measured by LiDAR 28, the shapes of the target objects, and the like, and information such as the distance to target objects that are measured by RADAR 30, the directions of the target objects, and the like may be stored in the database 52.

### Image Information

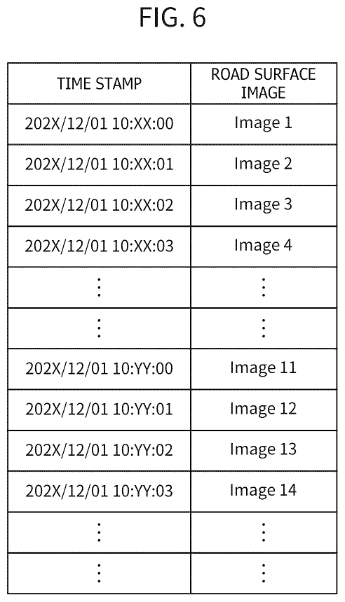

FIG. 6 is a diagram showing the image information that is stored in the database 52. As shown in FIG. 6, the road surface images are managed together with time stamps indicating the points in time at which they were captured.

### Road Surface Condition Determination Device

The server device 12 is further equipped with a road surface condition determination device 54 See FIG. 3). The road surface condition determination device 54 carries out processing of the road surface images using a convolutional neural network (hereinafter, CNN) algorithm, and thereby determines the road surface condition. The CNN is a method of deep learning and machine learning, and is a neural network specialized for images. The road surface condition determination device 54 includes a computation unit 56 and a storage unit 58.

The computation unit 56, for example, is a processor such as a CPU, a GPU, or the like. The computation unit 56 comprises a road surface image acquisition unit 60, an extraction unit 62, a route information acquisition unit 64, a specific region setting unit 66, and a road surface condition determination unit 68. The road surface image acquisition unit 60, the extraction unit 62, the route information acquisition unit 64, the specific region setting unit 66, and the road surface condition determination unit 68 are realized by programs that are stored in the storage unit 58 being executed in the computation unit 56. The road surface image acquisition unit 60, the extraction unit 62, the route information acquisition unit 64, the specific region setting unit 66, and the road surface condition determination unit 68 may be realized by an integrated circuit such as an ASIC, an FPGA, or the like. The road surface image acquisition unit 60, the extraction unit 62, the route information acquisition unit 64, the specific region setting unit 66, and the road surface condition determination unit 68 may be realized by an electronic circuit including a discrete device.

The storage unit 58 is a computer readable non-transitory tangible storage medium. The storage unit 58 is constituted by a non-illustrated volatile memory and a non-illustrated nonvolatile memory. As an example of the volatile memory, there may be cited a RAM or the like. As an example of the nonvolatile memory, there may be cited a ROM, a flash memory, or the like. Data and the like, for example, are stored in the volatile memory. Programs, tables, maps, and the like, for example, are stored in the nonvolatile memory. At least a portion of the storage unit 58 may be provided in the aforementioned processor, the integrated circuit, or the like. At least a portion of the storage unit 58 may be installed in a device that is connected via the network 16 to the server device 12.

### Road Surface Image Acquisition Unit

The road surface condition determination device 54 determines the road surface condition for each of the partial routes. Therefore, in the road surface image acquisition unit 60, from among a large number of road surface images that are stored in the database 52, there are acquired the road surface images in which there is photographed the road surface of the partial route for which the road surface condition is to be determined. Hereinafter, the partial route for which the road surface condition is to be determined may be referred to as a target partial route. Further, the road surface images acquired by the road surface image acquisition unit 60 may be referred to as target images.

Based on the information indicating the moving object positions and the time stamps contained in the travel information See FIG. 5) of the database 52, the periods during which the moving object 14 has traveled on the target partial route can be determined. The road surface image acquisition unit 60 acquires from the database 52, as the target images, the road surface images captured during a period in which the moving object 14 has traveled on the target partial route. A plurality of the road surface images are captured while the moving object 14 travels from the starting end to the terminal end of the partial route. Therefore, a plurality of the road surface images are acquired as the target images by the road surface image acquisition unit 60.

### Extraction Unit

The extraction unit 62, based on behavior information, extracts as extracted images a portion from among the plurality of target images acquired by the road surface image acquisition unit 60. The behavior information indicates, from among the aforementioned traveling information, information indicating the moving object position, or alternatively, information indicating the moving object velocity. Hereinafter, the information indicating the moving object position may be referred to as moving object position information. Further, the information indicating the moving object velocity may be referred to as moving object velocity information.

First, a description will be given concerning the extraction of images extracted based on moving object position information as the extracted images. Based on the moving object position information, deviations in the leftward/rightward direction behavior of the moving objects 14, i.e., wobbling of the moving objects 14, can be determined.

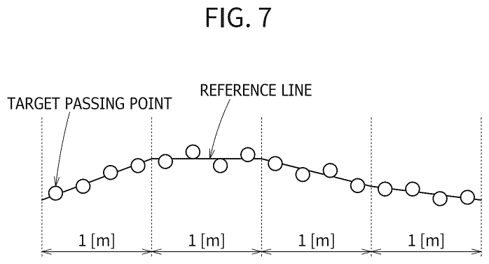

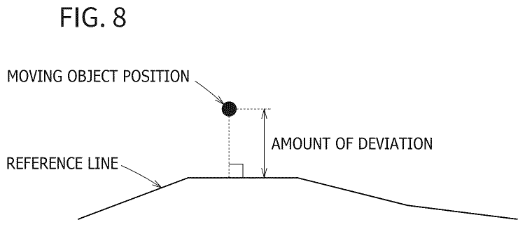

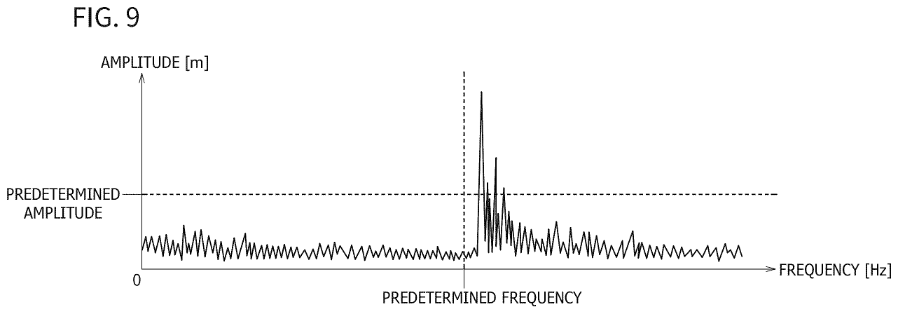

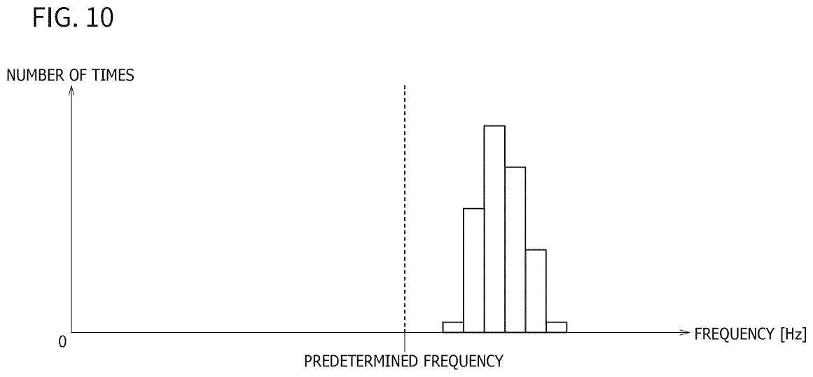

The extraction unit 62 obtains frequency components of an amount of deviation, which is a distance between the reference line and the moving object position at each of respective points in time. FIG. 7 is a diagram illustrating the reference line. FIG. 8 is a diagram illustrating the amount of deviation. FIG. 9 and FIG. 10 are diagrams illustrating the frequency components of the amount of deviation.

As noted previously, information indicating the target passing points is delivered from the server device 12 to the moving objects 14, and the automated driving control device 38 of the moving objects 14 controls the drive wheel motor 34 and the steering actuator 36 in a manner so that the moving objects 14 pass through the target passing points. As shown in FIG. 7, a least squares line is determined from the coordinates of the target passing points included in segments obtained by dividing the partial routes into 1 [m] segments, and such a least squares line is used as the reference line. The interval obtained by dividing the partial routes is not necessarily limited to being 1 [m].

As shown in FIG. 8, the amount of deviation is determined by the distance of a perpendicular line drawn from the moving object position to the reference line. By performing a fast Fourier transform on the amount of deviation of the moving object position at each of respective points in time from the reference line, the frequency components of the amount of deviation shown in FIG. 9 are obtained. The extraction unit 62 extracts the moving object position corresponding to the frequency components of the amount of deviation, which has a frequency that is greater than or equal to a predetermined frequency, and an amplitude that is greater than or equal to a predetermined amplitude. The extraction unit 62 extracts as the extracted images the target images that are captured at the extracted moving object positions.

The frequency components of the amount of deviation having a frequency of greater than or equal to the predetermined frequency and an amplitude of greater than or equal to the predetermined amplitude indicate that the moving objects 14 are wobbling relatively greatly in a comparatively short period. Such behavior is observed when the moving objects 14 are traveling on a rough road.

Instead of obtaining the frequency components of the amount of deviation, as shown in FIG. 10, there may be obtained frequencies for which the amplitude thereof appears to be greater than or equal to the p. etermined value for each of the frequencies.

Next, a description will be given concerning the extraction of images extracted based on moving object velocity information as the extracted images. Based on the moving object velocity information, deviations in the behavior in the frontward/rearward direction of the moving objects 14, i.e., a sudden deceleration of the moving objects 14, can be determined.

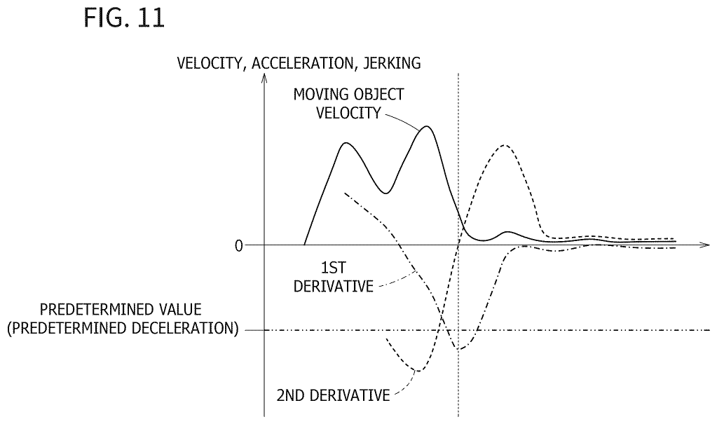

The extraction unit 62 determines a first derivative and a second derivative of the moving object velocity. FIG. 11 is a graph showing a change over time of the moving object velocity, the first derivative of the moving object velocity, and the second derivative of the moving object velocity. Moreover, it should be noted that, as shown in FIG. 11, since the first derivative values shown in FIG. 11 are obtained by differentiating the moving object velocity which is a discrete value, these values do not represent a gradient of the curve of the moving object velocity shown in FIG. 11. In the case that the first derivative values are less than or equal to a predetermined value, and further, the second derivative value is zero, the extraction unit 62 determines that the moving objects 14 have suddenly decelerated. The extraction unit 62 extracts, as the extracted images, road surface images corresponding to a moving object velocity for which the first derivative value is less than or equal to the predetermined value, and further, the second derivative value is zero. The second derivative value is not necessarily limited to being 0, and the extraction unit 62 may extract, as the extracted images, road surface images corresponding to a moving object velocity for which the first derivative value is less than the predetermined value, and further, for which the second derivative value lies within a predetermined range including 0.

The first derivative of the moving object velocity indicates an acceleration or a deceleration of the moving objects 14, and the second derivative of the moving object velocity indicates jerking of the moving objects 14. The first derivative value being less than or equal to the predetermined value can be stated otherwise as meaning that the deceleration of the moving objects 14 is less than or equal to a predetermined deceleration. A sudden deceleration of the moving objects 14 is observed when the moving objects 14 are traveling on a rough road.

### Route Information Acquisition Unit

The route information acquisition unit 64 acquires route information indicating the routes of the moving objects 14. The route information is used in order to identify, within the extracted images, specific regions 70, which are regions in which there is included the road surface on which the vehicle wheels of the moving objects 14 pass. The route information acquisition unit 64 acquires as the route information at least one of trajectory information, target route information, and estimated route information.

The trajectory information indicates trajectories of the moving objects 14 that are left on the road surface of a partial route. The trajectories of the moving objects 14, for example, are traces of the vehicle wheels of the moving objects 14. The trajectories of the moving objects 14 are derived from image processing of road surface images obtained by having photographed the road surface of the partial route.

The target route information is information indicating the target route determined from the coordinates of the aforementioned target passing points. The target route is a curve that passes through the target passing points. The target route is set for the moving objects 14.

The estimated route information is information indicating the route of the moving objects 14 which is estimated from the behavior of the moving objects 14. Hereinafter, the route of the moving objects 14 that is estimated from the behavior of the moving objects 14 may be referred to as an estimated route. A turning radius of the estimated route is determined by the following equation, using the moving object velocity and the yaw rate of the moving objects 14.

Turning Velocity=Moving object Velocity/Yaw Rate

### Specific Region Setting Unit

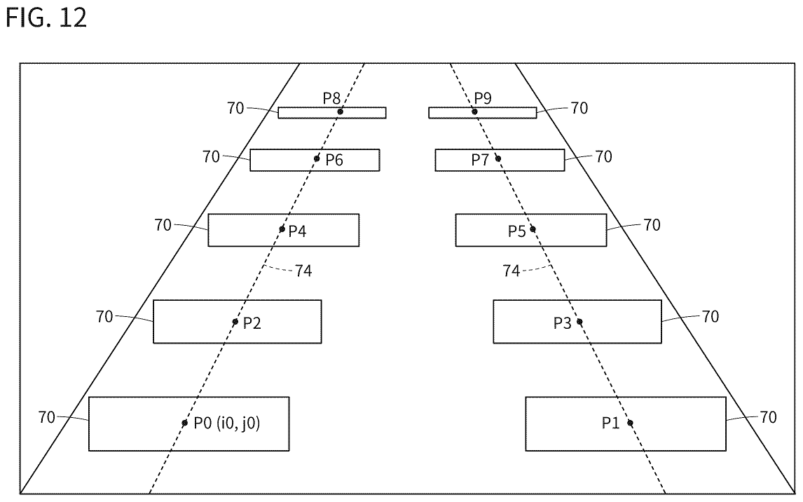

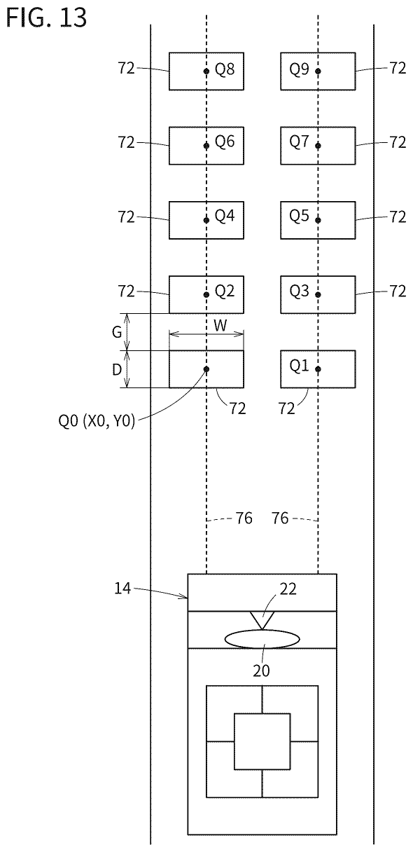

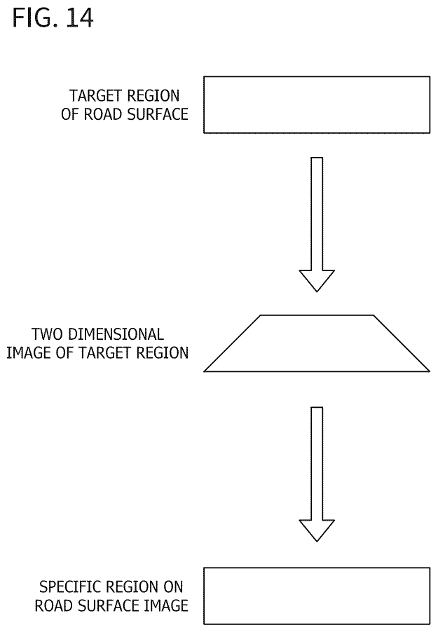

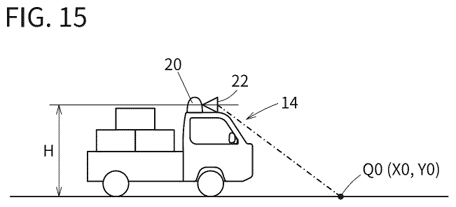

The specific region setting unit 66 sets the specific regions 70 on the extracted images based on the route information. FIG. 12 is a diagram illustrating the specific regions 70 on the extracted images. FIG. 13 is a diagram illustrating target regions 72 on a road surface. FIG. 14 is a diagram illustrating a conversion from the target regions 72 on the road surface to the specific regions 70 on the extracted images. FIG. 15 is a diagram illustrating a method of converting a position of a specific point on the road surface into a position of a point on the road surface images.

FIG. 12 shows one of the extracted images that is displayed on a non-illustrated display unit. The shape of the specific regions 70 is a rectangular shape. A plurality of the specific regions 70 which are separated at intervals from each other are set on the extracted images. Centers P (P0 to P9) of the specific regions 70 are positioned on a trajectory image 74 that is shown on the road surface images. The trajectory image 74 shows the positions where the vehicle wheels of the moving objects 14 pass on the road surface. The trajectory image 74 is generated based on the route information acquired by the route information acquisition unit 64.

The specific regions 70 are regions corresponding to the target regions 72 on the road surface shown in FIG. 13. The shape of the target regions 72 is of a rectangular shape, and centers Q (Q0 to Q9) of the target regions 72 are positioned on trajectories 76 on the road surface. The vehicle wheels of the moving objects 14 pass over the trajectories 76. The target regions 72 have a width W [m] and a depth D [m]. The target regions 72 that are adjacent to each other in the frontward/rearward direction are spaced apart at intervals of G [m].

The camera 22 of the moving objects 14 captures images of the road surface from diagonally upward thereof. Therefore, the two-dimensional images obtained by capturing images of the target regions 72 which are of a rectangular shape as shown in the first row of FIG. 14 become of a trapezoidal shape as shown in the second row of FIG. 14. The specific region setting unit 66 converts the target regions 72, which are of a trapezoidal shape on the two-dimensional image, into a rectangular shape as shown in the third row of FIG. 14, and sets them as the specific regions 70.

In the case of converting the position of a specific point on the road surface (for example, the point Q0 in FIG. 13) to the position of a point on the road surface images (for example, the point P0 in FIG. 12), the coordinates are converted using the following equations. Moreover, as shown in FIG. 15, the height from the road surface of the optical axis of the camera 22 of the moving objects 14 is set to H [m]. Further, the focal length of the camera 22 is set to f [m]. The size in the height direction of one pixel of the image sensor of the camera 22 is λi [m], and the size thereof in the horizontal direction is λj [m]. Furthermore, the distance in the frontward/rearward direction between the center (principal point) of the lens and the point Q0 is set to X0 [m], and the distance in the leftward/rightward direction between the center (principal point) of the lens and the point Q0 is set to Y0 [m]. Further, the number of pixels in the height direction between the center of the picture element of the camera 22 and the point P0 is i0 [pixel], and the number of pixels in the leftward/rightward direction between the center of the picture element and the point P0 is j0 [pixel].

$$i 0 = ( H \cdot f ) / ( X 0 \cdot λ i )$$

$$j 0 = ( Y 0 \cdot f ) / ( X 0 \cdot λ j )$$

### Road Surface Condition Determination Unit

The road surface condition determination unit 68 carries out processing by the CNN with respect to specific region images, which are images within the specific regions 70.

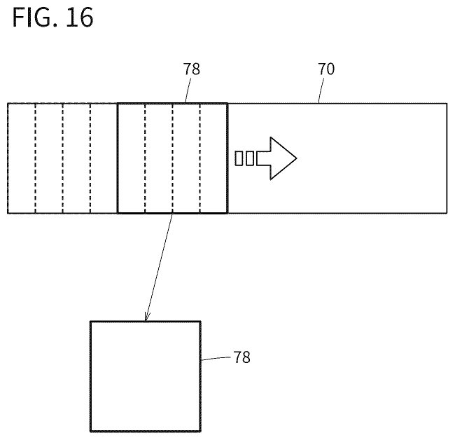

The road surface condition determination unit 68 further sets a processing region 78 within the specific regions 70. FIG. 16 is a diagram illustrating the processing region 78. The shape of the processing region 78 is square shaped. A length of one side of the processing region 78 is less than or equal to the length of a short side of the specific regions 70. The road surface condition determination unit 68, while scanning the processing region 78 within the specific regions 70, processes the specific region images included in the processing region 78 each time that the processing region 78 moves.

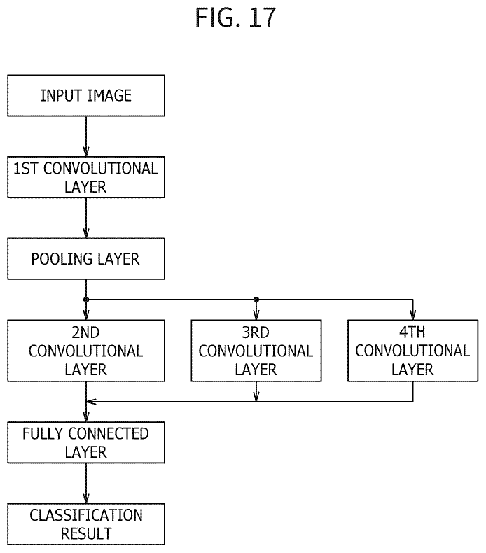

FIG. 17 is a diagram showing the processing carried out by the CNN. By the CNN that is used in the present embodiment, in a first convolutional layer, a square shaped kernel is applied with respect to the images (the input images) in each of the processing regions 78, and thereby a characteristic value is extracted. In the first convolutional layer, rather than characteristic amounts indicating whether or not the road surface condition is satisfactory or non-satisfactory, common characteristic amounts of the road surface are extracted.

In a pooling layer, images indicating the characteristic amounts extracted in the first convolution layer are reduced in size according to a predetermined rule. The images processed in the pooling layer are transmitted to a second convolutional layer, a third convolutional layer, and a fourth convolutional layer.

In the second convolutional layer, for example, in an off road surface, characteristic amounts of such a surface (Class_1) in a state in which it is difficult for the moving objects 14 to travel are extracted. In the third convolutional layer, for example, although there is an off road surface, characteristic amounts of such a surface (Class_2) in a state in which it is possible for the moving objects 14 to travel are extracted. In the fourth convolutional layer, for example, characteristic amounts of a surface (Class_3) which is an asphalt surface are extracted.

In a fully connected layer, the state of the road surface that is photographed in the input image is classified based on the characteristic amounts extracted in each of the second convolutional layer, the third convolutional layer, and the fourth convolutional layer. The probability that the road surface condition is Class_1, the probability that the road surface condition is Class_2, and the probability that the road surface condition is Class_3 are output as the classification result.

Hereinafter, the road surface condition of Class_1 will be referred to as a rough road. Further, the road surface condition of Class_2 and Class_3 will be referred to as a non-rough road. The probability that the road surface condition is Class_1 is expressed as a rough road probability θ(i) (i=0 to m). The rough road probability θ(i) is expressed as a numerical value that is greater than or equal to 0 and less than or equal to 1.

In order to remove noise from the rough road probability θ(i), a filtering process is carried out based on the following equation. μ(i) denotes the rough road probability after the filtering process.

$$μ ( i ) = \frac{1}{2 n + 1} {\sum }_{k = - n}^{n} θ ( i + k )$$

Among the rough road probabilities μ(i), the rough road probability μ(i) having the largest value from among three or more consecutive values that are greater than or equal to a threshold value is output as a rough road probability σk of the target regions 72 corresponding to the specific regions 70.

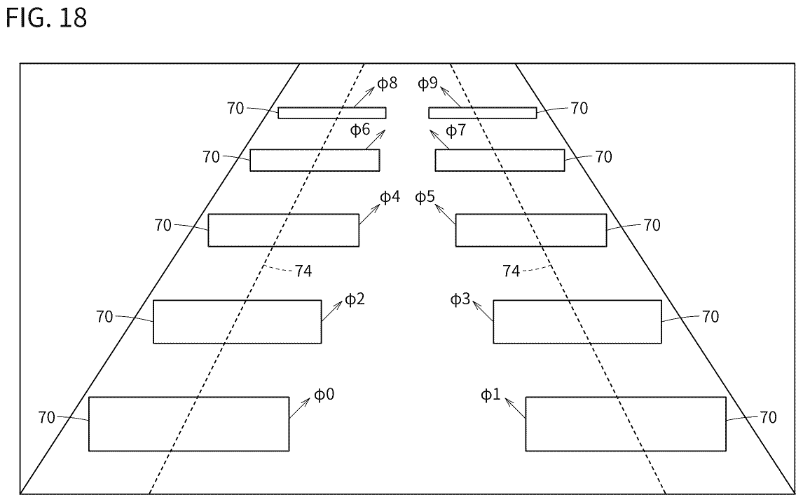

FIG. 18 is a diagram illustrating a determination of the road surface condition with respect to the extracted images. In the example shown in FIG. 18, rough road probabilities φ0 to φ9 are output for each of the specific regions 70. Among the rough road probabilities φ0 to φ9, the rough road probability ok having the maximum value is linked to the extracted images as a rough road probability corresponding to this extracted image.

In the case that the number of the extracted images extracted from the target image is one, the road surface condition determination unit 68 outputs the rough road probability associated with this one extracted image as a rough road probability p of the target partial route. In the case that the number of the extracted images extracted from the target image is a plurality, the road surface condition determination unit 68 outputs a maximum rough road probability from among the rough road probabilities associated with each of the extracted images as the rough road probability p of the target partial route.

### Route Searching Device

The server device 12 further comprises a route searching device 80 See FIG. 3). The route searching device 80, based on the map information that is shown in the graph, searches for a route that the moving objects 14 should travel along from the departure point to the destination point. The route searching device 80 includes a computation unit 82 and a storage unit 84.

The computation unit 82, for example, is a processor such as a CPU, a GPU, or the like. The computation unit 82 comprises a travel time period acquisition unit 86, an estimated necessary time period calculation unit 88, a weighting coefficient setting unit 90, a searching unit 92, and an information transmission unit 94. The travel time period acquisition unit 86, the estimated necessary time period calculation unit 88, the weighting coefficient setting unit 90, the searching unit 92, and the information transmission unit 94 are realized by programs that are stored in the storage unit 84 being executed in the computation unit 82. The travel time period acquisition unit 86, the estimated necessary time period calculation unit 88, the weighting coefficient setting unit 90, the searching unit 92, and the information transmission unit 94 may be realized by an integrated circuit such as an ASIC, an FPGA, or the like. The travel time period acquisition unit 86, the estimated necessary time period calculation unit 88, the weighting coefficient setting unit 90, the searching unit 92, and the information transmission unit 94 may be realized by an electronic circuit including a discrete device.

The storage unit 84 is a computer readable non-transitory tangible storage medium. The storage unit 84 is constituted by a non-illustrated volatile memory and a non-illustrated nonvolatile memory. As an example of the volatile memory, there may be cited a RAM or the like. As an example of the nonvolatile memory, there may be cited a ROM, a flash memory, or the like. Data and the like, for example, are stored in the volatile memory. Programs, tables, maps, and the like, for example, are stored in the nonvolatile memory. At least a portion of the storage unit 84 may be provided in the aforementioned processor, the integrated circuit, or the like. At least a portion of the storage unit 84 may be installed in a device that is connected via the network 16 to the server device 12.

The route searching device 80 searches for a route based on cost information associated with the edges that make up the graph of the map information. The cost information is information indicating the cost. As noted previously, the cost is the necessary time period required for the moving objects 14 to travel from the starting end to the terminal end of the partial route corresponding to the edges. The cost associated with the edges is the necessary time period required in the case that the road surface condition of all of the segments of the partial route are a non-rough road. Therefore, in the case that the partial route includes a rough road segment, the actual necessary time period will be longer than the cost associated with the edges.

Therefore, the route searching device 80 sets a weighting coefficient with respect to each of the edges, and corrects the cost by using the weighting coefficient. The route searching device 80 calculates an estimated necessary time period, which is an estimate of the necessary time period. Furthermore, the route searching device 80 sets the weighting coefficient based on the estimated necessary time period.

### Travel Time Period Acquisition Unit

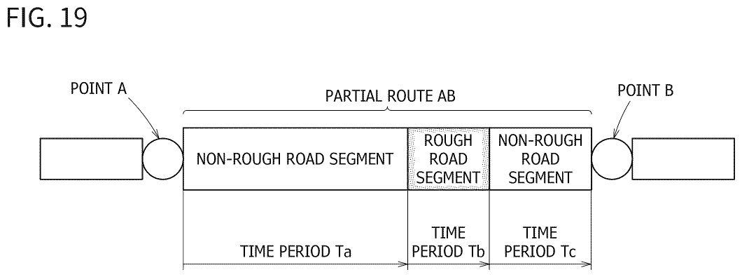

The travel time period acquisition unit 86 acquires the travel time, which is the time period for the moving objects 14 to travel along the partial route. FIG. 19 is a diagram illustrating the travel time period. FIG. 19 shows an example of the travel time period when the moving objects 14 travel from a point A to a point B along a partial route AB. In the partial route AB, there are included a non-rough road segment and a rough road segment.

The travel time period is shown as the sum of the first travel time period and the second travel time period. In the example shown in FIG. 19, the travel time period is the sum (=Ta+Tb+Tc) of a time period Ta and a time period Tc during which the moving objects 14 travel on the non-rough road segment, and a time period Tb during which the moving objects 14 travel on the rough road segment, within the partial route AB. The first travel time period is the sum (=Ta+Tc) of the time period Ta and the time period Tc during which the moving objects 14 travel on the non-rough road segment within the partial route AB. In the example shown in FIG. 19, the second travel time period is the time period Tb during which the moving objects 14 have traveled on the rough road segment within the partial route AB.

### Estimated Necessary Time Period Calculation Unit

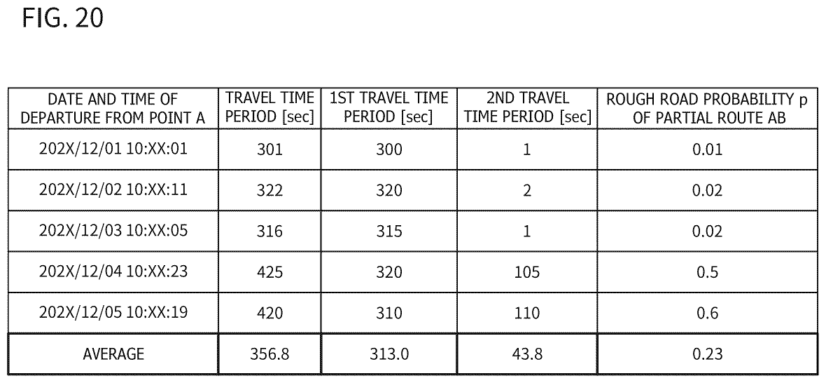

The estimated necessary time period calculation unit 88 calculates the estimated necessary time period. FIG. 20 is a table showing an example of the travel time period, the first travel time period, the second travel time period, and the rough road probability p of the partial route AB, obtained through the moving objects 14 having traveled along the partial route AB. FIG. 20 shows an example in which the moving objects 14 travel along the partial route AB from point A to point B one time per day at roughly 10:00 AM.

The estimated necessary time period calculation unit 88 calculates the estimated necessary time period using the following equation: T_i=Tod_i+Trt_i. In the equation, the term “T_i” indicates the estimated necessary time period. The term “Tod_i” indicates a first average travel time period, which is an average of the first travel time periods. The term “Trt_i” indicates a value obtained by multiplying a second average travel time period, which is an average of the second travel time periods, by the average of the rough road probabilities p. In the example shown in FIG. 20, the estimated necessary time period T_i is 323.074 [sec].

### Weighting Coefficient Setting Unit

The weighting coefficient setting unit 90 calculates the weighting coefficient using the following equation: C=1+ (Trt_i/T_i). In the equation, the term “C” represents the weighting coefficient. In the example shown in FIG. 20, the weighting coefficient C is 1.031.

### Searching Unit

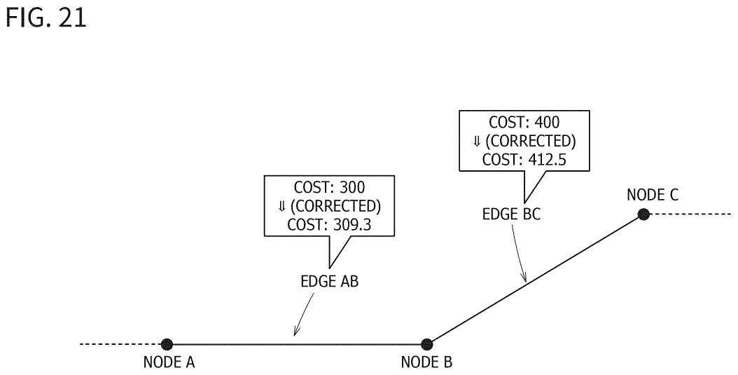

The searching unit 92 searches for a route based on the cost that has been corrected by the weighting coefficient. FIG. 21 is a diagram showing the map information after the cost has been corrected by the weighting coefficient.

The searching unit 92 searches for a combination of the edges that are capable of reaching from a starting point node indicating the departure point to an ending point node indicating the destination point. From among the combination of edges that are searched, a combination of partial routes corresponding to the combination having the smallest total cost after having been corrected is determined as the route of the moving objects 14.

### Information Transmission Unit

The information transmission unit 94 sets the target passing points along the determined route. The information transmission unit 94 transmits to the moving objects 14 via the network 16 the information indicating the target passing points that have been set.

### Road Surface Condition Determination Process

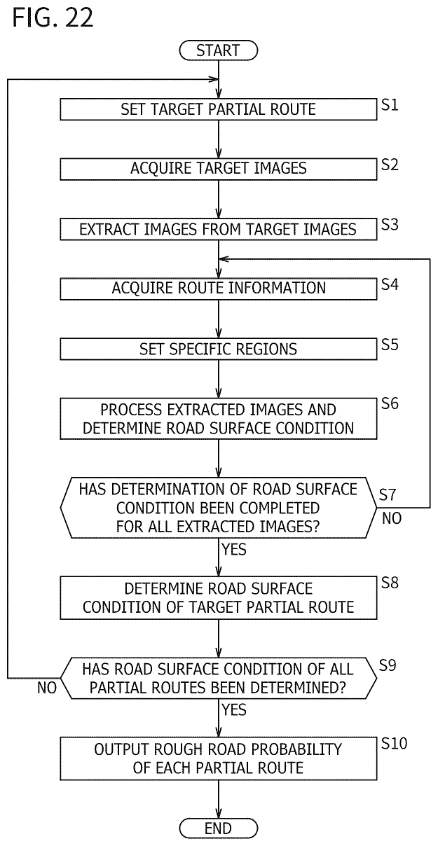

FIG. 22 is a flowchart showing a road surface condition determination process executed by the road surface condition determination device 54.

In step S1, the road surface image acquisition unit 60 sets a partial route for which the determination of the road surface condition thereof has not been completed as the target partial route. Thereafter, the process transitions to step S2.

In step S2, the road surface image acquisition unit 60 acquires from the database 52, as the target images, the road surface images captured during a period in which the moving objects 14 have traveled on the target partial route. Thereafter, the process transitions to step S3.

In step S3, the extraction unit 62 extracts as extracted images a portion of the extracted images from among the plurality of target images. Thereafter, the process transitions to step S4.

In step S4, the route information acquisition unit 64 acquires the route information of the moving objects 14. Thereafter, the process transitions to step S5.

In step S5, the specific region setting unit 66 sets the specific regions 70 on the extracted images based on the route information. Thereafter, the process transitions to step S6.

In step S6, the road surface condition determination unit 68 processes the extracted images and thereby determines the road surface condition. Thereafter, the process transitions to step S7.

In step S7, it is determined whether or not the determination of the road surface condition has been completed with respect to all of the extracted images. In the case it is determined that the determination of the road surface condition has been completed with respect to all of the extracted images Step S7: YES), the process transitions to step S8. In the case it is determined that there is an extracted image for which the determination of the road surface condition has not been completed Step S7: NO), the process returns to step S4.

In step S8, based on the determination result of the road surface condition with respect to the extracted images corresponding to the target partial route, the road surface condition determination unit 68 determines the road surface condition of the target partial route. Thereafter, the process transitions to step S9.

In step S9, the road surface condition determination unit 68 determines whether or not the determination of the road surface conditions for all of the partial routes has been completed. In the case it is determined that the determination of the road surface condition has been completed with respect to all of the partial routes Step S9: YES), the process transitions to step S10. In the case it is determined that there is a partial route for which the determination of the road surface condition has not been completed Step S9: NO), the process returns to step S1.

In step S10, the road surface condition determination unit 68 outputs the rough road probability of each of the partial routes. Thereafter, the road surface condition determination process comes to an end.

### Route Searching Process

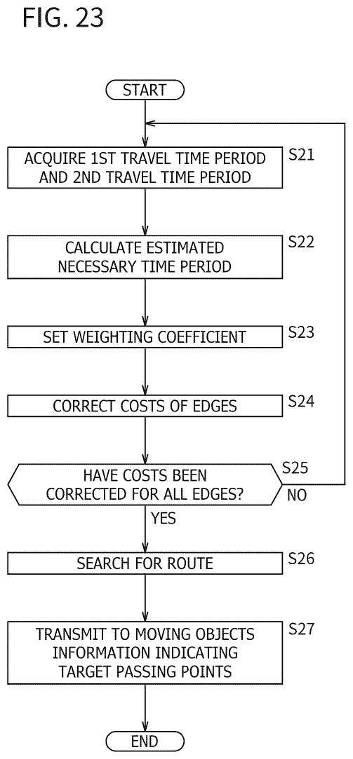

FIG. 23 is a flowchart showing a route searching process executed by the route searching device 80.

In step S21, the travel time period acquisition unit 86 selects edges for which the cost is to be corrected, and acquires the first travel time period and the second travel time period of the partial route corresponding to the selected edges. Thereafter, the process transitions to step S22.

In step S22, the estimated necessary time period calculation unit 88 calculates the estimated necessary time period, based on the first average travel time period, which is the average of the first travel time periods, the second average travel time period, which is the average of the second travel time periods, and the determination result of the road surface condition of the partial route corresponding to the edges whose cost is to be corrected. Thereafter, the process transitions to step S23.

In step S23, the weighting coefficient setting unit 90 sets the weighting coefficient, based on the estimated necessary time period, the second average travel time period which is the average of the second travel time periods, and the determination result of the road surface condition of the partial route corresponding to the edges whose cost is to be corrected. Thereafter, the process transitions to step S24.

In step S24, the weighting coefficient setting unit 90 corrects the cost of the edges by using the weighting coefficient. Thereafter, the process transitions to step S25.

In step S25, the weighting coefficient setting unit 90 determines whether or not the correction of the costs of all of the edges has been completed. In the case it is determined that the correction of the costs of all of the edges has been completed Step S25: YES), the process transitions to step S26. In the case it is determined that there is a partial route for which the correction of the cost has not been completed Step S25: NO), the process returns to step S21.

In step S26, the searching unit 92 searches for a route based on the map information after the cost of each of the edges has been corrected, and determines the route having the smallest cost. Thereafter, the process transitions to step S27.

In step S27, the information transmission unit 94 sets target passing points that are aligned along the route that was determined, and transmits to the moving objects 14 via the network 16 the information indicating the target passing points that have been set. Thereafter, the route searching process comes to an end.

### Operations and Advantageous Effects

The road surface condition determination device 54, without carrying out CNN processing on all of the target images, extracts target images that are expected to have photographed therein road surfaces whose condition is poor, and carries out CNN processing with respect to the extracted images that are the target images that have been extracted.

Furthermore, the road surface condition determination device 54, without carrying out CNN processing on the entirety of the extracted images, carries out CNN processing with respect to the specific region image of the specific regions 70 in which the road surface through which the vehicle wheels of the moving objects 14 pass is included.

In accordance with this feature, it is possible to reduce the size of the image to be processed by the CNN, thereby reducing the processing load on the CNN. Further, the time required to determine the road surface condition can be reduced.

The road surface condition determination device 54 extracts, as extracted images, road surface images captured at a time when the moving objects 14 wobble or when the moving objects 14 suddenly decelerate. In accordance with this feature, road surface images having photographed therein road surfaces whose condition is poor can be extracted as the extracted images.

The road surface condition determination device 54 sets the specific regions 70 on the extracted images, in a manner so that the center of the specific regions 70 is positioned on the trajectory image 74 that is on the road surface image. The trajectory image 74 shows the positions where the vehicle wheels of the moving objects 14 pass on the road surface. In accordance with this feature, it is possible to determine the condition of the road surface on which the vehicle wheels of the moving objects 14 pass.

The road surface condition determination device 54 sets the rectangular shaped specific regions 70 on the extracted images. The kernel used in the CNN is square shaped. Therefore, for example, compared to a case in which the specific regions 70 are of a trapezoidal shape, processing by the CNN can be carried out efficiently in the rectangular shaped specific regions 70.

The route searching device 80 sets the weighting coefficient according to the road surface condition of the partial route, and corrects the cost of the edges using the weighting coefficient. In accordance with this feature, a route can be searched to shorten the necessary time period required when the moving objects 14 actually travel.

### Modification

In the above-described embodiment, the server device 12 is equipped with the road surface condition determination device 54 and the route searching device 80. In contrast to this feature, at least one of the road surface condition determination device 54 and the route searching device 80 may be provided in the moving objects 14.

In relation to the above-described embodiment, the following supplementary notes are further disclosed.

### Supplementary Note 1

The road surface condition determination device (54) of the present disclosure comprises the image acquisition unit (60) configured to chronologically acquire the road surface image and behavior information in a manner so that the road surface image and the behavior information are associated with each other, the road surface image being obtained by capturing an image of the road surface on which the moving object (14) is traveling, the behavior information being indicative of behavior of the moving object at the time when the road surface image is captured, the extraction unit (62) configured to extract, as the extracted image, the road surface image that is a part of the plurality of the road surface images, based on the behavior information, and the road surface condition determination unit (68) configured to determine a condition of the road surface, as the road surface condition, by processing the extracted image. In accordance with this feature, it is possible to reduce the size of the image to be processed, thereby reducing the processing load. Further, the time required to determine the road surface condition can be reduced.

### Supplementary Note 2

In the road surface condition determination device according to Supplementary Note 1, the behavior information includes position information indicative of the moving body position that is the position of the moving body, and velocity information indicative of the moving body velocity that is the velocity of the moving body, and the extraction unit may extract the extracted image based on the position information or the velocity information. In this manner, it is possible to extract road surface images showing a worse road surface condition can be extracted.

### Supplementary Note 3

In the road surface condition determination device according to Supplementary Note 2, the extraction unit may extract, as the extracted image, the road surface image that is associated with the moving body position corresponding to the frequency component of the amount of deviation having the frequency greater than or equal to the predetermined frequency and the amplitude greater than or equal to the predetermined amplitude, the amount of deviation being the distance between the reference line set in accordance with a target passing point to be passed through by the moving object and the moving object position at each point in time.

### Supplementary Note 4

In the road surface condition determination device according to Supplementary Note 2, the extraction unit may extract, as the extracted image, the road surface image that is associated with the moving body velocity at which the deceleration of the moving object obtained from the moving body velocity is greater than or equal to a predetermined deceleration.

### Supplementary Note 5

In the road surface condition determination device according to any one of Supplementary Notes 1 to 4, the road surface image may be captured by the imaging device (22) mounted on the moving object.

### Supplementary Note 6

In the road surface condition determination device according to any one of Supplementary Notes 1 to 5, the road surface condition determination unit may extract the characteristic value of the extracted image by processing the extracted image by means of deep learning, and may determine, based on the characteristic value, the road surface condition of the road surface that is captured in the extracted image.

### Supplementary Note 7

In the road surface condition determination device according to Supplementary Note 6, the deep learning may utilize a convolutional neural network.

### Supplementary Note 8

The server device according to the present disclosure is the server device in the information processing system (10) equipped with the moving object, and the server device that is capable of communicating with the moving object, the server device comprising the road surface condition determination device according to any one of Supplementary Notes 1 to 7.

### Supplementary Note 9

The moving object according to the present disclosure is equipped with the road surface condition determination device according to any one of Supplementary Notes 1 to 7.

### Supplementary Note 10

The route searching device (80) according to the present disclosure is configured to search for the route in order for the moving object to arrive from the starting node representing the departure point to the ending node representing the destination point, using the graph made up from the nodes representing points and the edges representing the partial route connecting two points, each of the edges being associated with cost information indicating a cost required for the moving object to travel on the partial route corresponding to the edges, comprising the weighting coefficient setting unit (90) configured to set the weighting coefficient in order to correct the cost, corresponding to the road surface condition of the partial route as determined by the road surface condition determination device according to any one of Supplementary Notes 1 to 7, and the searching unit (92) configured to search for the route based on the cost that has been corrected using the weighting coefficient. In accordance with this feature, the cost can be made to approach the necessary time period required when the moving object actually travels.

### Supplementary Note 11

In the route searching device according to Supplementary Note 10, the cost may be the necessary time period required for the moving object to travel from the starting end to the terminal end of the partial route corresponding to the edges, and the weighting coefficient setting unit may set the weighting coefficient based on the estimated necessary time period, which is the estimated value of the necessary time period determined according to the road surface condition of the partial route.

### Supplementary Note 12

In the route searching device according to Supplementary Note 11, there may further be provided the travel time period acquisition unit (86) that acquires the first travel time period during which the moving object travels on the non-rough road segment within the partial route, and the second travel time period during which the moving object travels on the rough road segment within the partial route, the first travel time period and the second travel time period may be acquired from the moving object every time that the moving object travels along the partial route, the road surface condition determination device may calculate, as the rough road probability, the probability that a rough road is included in the partial route, and the estimated necessary time period may be determined based on the first average travel time period, which is the average of the first travel time period, and the value obtained by multiplying the second average travel time period, which is the average of the second travel time period, by the rough road probability.

### Supplementary Note 13

In the route searching device according to Supplementary Note 12, in the case that the weighting coefficient is denoted by C, the estimated necessary time period is denoted by T_i, and the value obtained by multiplying the second average travel time period by the rough road probability is denoted by Trt_i, the weighting coefficient may be determined by the equation: C=1+ (Trt_i/T_i).

### Supplementary Note 14

The road surface condition determination method of the present disclosure comprises: chronologically acquiring the road surface image and behavior information in a manner so that the road surface image and the behavior information are associated with each other, the road surface image being obtained by capturing the image of the road surface on which the moving object (14) is traveling, the behavior information being indicative of behavior of the moving object at the time when the road surface image is captured, extracting, as the extracted image, the road surface image that is a part of the plurality of the road surface images, based on the behavior information, and determining the condition of the road surface, as the road surface condition, by processing the extracted image.

### Supplementary Note 15

In the road surface condition determination method according to Supplementary Note 14, the behavior information includes position information indicative of the moving body position that is the position of the moving body, velocity information indicative of the moving body velocity that is the velocity of the moving body, and the extraction unit may extract the extracted image based on the position information or the velocity information.

### Supplementary Note 16

In the road surface condition determination method according to Supplementary Note 15, in extracting the extracted image, the extracted image may be the road surface image that is associated with the moving body position corresponding to the frequency component of an amount of deviation having the frequency greater than or equal to the predetermined frequency and the amplitude greater than or equal to the predetermined amplitude, the amount of deviation being the distance between a reference line set in accordance with target passing points to be passed through by the moving object and the moving object position at respective points in time.

### Supplementary Note 17

In the road surface condition determination method according to Supplementary Note 15, in extracting the extracted image, the extracted image may be the road surface image that is associated with the moving body velocity at which the deceleration of the moving object obtained from the moving body velocity is greater than or equal to the predetermined deceleration.

### Supplementary Note 18

In the road surface condition determination method according to any one of Supplementary Notes 14 to 17, the road surface image may be captured by an imaging device mounted on the moving object.

### Supplementary Note 19

In the road surface condition determination method according to any one of Supplementary Notes 14 to 18, in determining the road surface condition, the characteristic value of the extracted image may be extracted by processing the extracted image by means of deep learning to determine, based on the characteristic value, the road surface condition of the road surface that is captured in the extracted image.

### Supplementary Note 20

In the road surface condition determination method according to Supplementary Note 19, the deep learning may utilize a convolutional neural network.

### Supplementary Note 21

The program of the present disclosure causes the computer to execute the road surface condition determination method according to any one of Supplementary Notes 14 to 20.

### Supplementary Note 22

The computer readable non-transitory storage medium of the present disclosure stores the program described in Supplementary Note 21.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the aforementioned embodiments, the order of each of the operations and the order of each of the processes are illustrated as examples, and the present invention is not necessarily limited to these features. Further, the same also applies to cases in which numerical values or mathematical expressions are used in the description of the aforementioned embodiments.

What is claimed is:

1. A road surface condition determination device, comprising one or more processors that execute computer-executable instructions stored in a memory, wherein the one or more processors execute the computer-executable instructions to cause the road surface condition determination device to:
chronologically acquire a road surface image and behavior information in a manner so that the road surface image and the behavior information are associated with each other, the road surface image being obtained by capturing an image of a road surface on which a moving object is traveling, the behavior information being indicative of behavior of the moving object at a time when the road surface image is captured;
extract, as an extracted image, the road surface image that is a part of a plurality of the road surface images, based on the behavior information; and
determine a condition of the road surface, as a road surface condition, by processing the extracted image.

2. The road surface condition determination device according to claim 1, wherein
the behavior information includes position information indicative of a moving body position that is a position of the moving body, and velocity information indicative of a moving body velocity that is a velocity of the moving body, and
the one or more processors cause the road surface condition determination device to:
extract the extracted image based on the position information or the velocity information.

3. The road surface condition determination device according to claim 2, wherein the one or more processors cause the road surface condition determination device to:
extract, as the extracted image, the road surface image that is associated with the moving body position corresponding to a frequency component of an amount of deviation having a frequency greater than or equal to a predetermined frequency and an amplitude greater than or equal to a predetermined amplitude, the amount of deviation being a distance between a reference line set in accordance with a target passing point to be passed through by the moving object and the moving object position at each point in time.

4. The road surface condition determination device according to claim 2, wherein the one or more processors cause the road surface condition determination device to:
extract, as the extracted image, the road surface image that is associated with the moving body velocity at which a deceleration of the moving object obtained from the moving body velocity is greater than or equal to a predetermined deceleration.

5. The road surface condition determination device according to claim 1, wherein the road surface image is captured by an imaging device mounted on the moving object.

6. The road surface condition determination device according to claim 1, wherein the one or more processors cause the road surface condition determination device to:
extract a characteristic value of the extracted image by processing the extracted image by means of deep learning, and
based on the characteristic value, determine the road surface condition of the road surface that is captured in the extracted image.

7. The road surface condition determination device according to claim 6, wherein the deep learning utilizes a convolutional neural network.

8. A server device in an information processing system comprising a moving object, and the server device configured to communicate with the moving object, the server device comprising:
the road surface condition determination device according to claim 1.

9. A moving object equipped with the road surface condition determination device according to claim 1.

10. A route searching device configured to search for a route in order for a moving object to arrive from a starting node representing a departure point to an ending node representing a destination point, using a graph made up from nodes representing points and edges representing a partial route connecting two points, the route searching device comprising one or more processors that execute computer-executable instructions stored in a memory,
wherein the one or more processors execute the computer-executable instructions to cause the route searching device to:
associate each of the edges with cost information indicating a cost required for the moving object to travel on the partial route corresponding to the edges;
set a weighting coefficient in order to correct the cost, corresponding to the road surface condition of the partial route as determined by the road surface condition determination device according to claim 1; and
search for the route based on the cost that has been corrected using the weighting coefficient.

11. The route searching device according to claim 10, wherein:
the cost is a necessary time period required for the moving object to travel from a starting end to a terminal end of the partial route corresponding to the edges; and
the one or more processors cause the route searching device to set the weighting coefficient based on an estimated necessary time period, which is an estimated value of the necessary time period determined according to the road surface condition of the partial route.

12. The route searching device according to claim 11, wherein
the road surface condition determination device calculates, as a rough road probability, a probability that a rough road is included in the partial route, and
the one or more processors cause the route searching device to:
acquire a first travel time period during which the moving object travels on a non-rough road segment within the partial route, and a second travel time period during which the moving object travels on a rough road segment within the partial route;
acquire the first travel time period and the second travel time period from the moving object every time that the moving object travels along the partial route; and
determine an estimated necessary time period based on a first average travel time period, which is an average of the first travel time periods, and a value obtained by multiplying a second average travel time period, which is an average of the second travel time periods, by the rough road probability.

13. The route searching device according to claim 12, wherein, in the case that the weighting coefficient is denoted by C, the estimated necessary time period is denoted by T_i, and the value obtained by multiplying the second average travel time period by the rough road probability is denoted by Trt_i, the weighting coefficient is determined by a following equation: C=1+(Trt_i/T_i).

14. A road surface condition determination method executed by one or more processors, the road surface condition determination method comprising:
chronologically acquiring a road surface image and behavior information in a manner so that the road surface image and the behavior information are associated with each other, the road surface image being obtained by capturing an image of a road surface on which a moving object is traveling, the behavior information being indicative of behavior of the moving object at a time when the road surface image is captured;
extracting, as an extracted image, the road surface image that is a part of a plurality of the road surface images, based on the behavior information; and
determining a condition of the road surface, as a road surface condition, by processing the extracted image.

15. The road surface condition determination method according to claim 14, wherein the behavior information includes position information indicative of a moving body position that is a position of the moving body, and velocity information indicative of a moving body velocity that is a velocity of the moving body, and
the extracted image is extracted based on the position information or the velocity information.

16. The road surface condition determination method according to claim 15, wherein the extracted image is the road surface image that is associated with the moving body position corresponding to a frequency component of an amount of deviation having a frequency greater than or equal to a predetermined frequency and an amplitude greater than or equal to a predetermined amplitude, the amount of deviation being a distance between a reference line set in accordance with a target passing point to be passed through by the moving object and the moving object position at each point in time.

17. The road surface condition determination method according to claim 15, wherein the extracted image is the road surface image that is associated with the moving body velocity at which a deceleration of the moving object obtained from the moving body velocity is greater than or equal to a predetermined deceleration.

18. The road surface condition determination method according to claim 14, wherein the road surface image is captured by an imaging device mounted on the moving object.

19. The road surface condition determination method according to claim 14, wherein a characteristic value of the extracted image is extracted by processing the extracted image by means of deep learning to determine, based on the characteristic value, the road surface condition of the road surface that is captured in the extracted image.

20. A computer readable non-transitory storage medium in which there is stored a program for causing a computer to execute the road surface condition determination method according to claim 14.
